(19) United States
(12) Patent Application Publication
(10) Pub. No.: US 2022/0394074 A1
(43) Pub. Date: Dec. 8, 2022

(54) SYSTEM AND METHOD FOR FAULT-TOLERANT PLAYBACK OF STORED DIGITAL CONTENT

(71) Applicant: ARRIS ENTERPRISES LLC, Suwanee, GA (US)

(72) Inventors: Ramesh Narayanaswamy, Bangalore (IN); Sandeep Guddekoppa Suresh, Bangalore (IN)

(73) Assignee: ARRIS ENTERPRISES LLC, Suwanee, GA (US)

(21) Appl. No.: 17/830,037

(22) Filed: Jun. 1, 2022

(30) Foreign Application Priority Data
Jun. 3, 2021 (IN) 202141024797

(51) Int. Cl. H04L 65/70; H04N 21/434; G06F 16/70

(52) U.S. Cl. CPC H04L 65/70; H04N 21/4343; G06F 16/70

(57) ABSTRACT

A system and method enabling the storage and retrieval of packetized digital content data in a manner which minimizes the detrimental effects of dropped data packets. The dropped packets, encoded in accordance with a first profile, are detected and corresponding data packets obtained from an alternate profile of the digital content are substituted for the missing packets when the data is retrieved. Upon retrieval, the stored data packets are decoded in accordance with protocols associated with the particular profile from which each stored packet was obtained.

### CROSS-REFERENCE TO RELATED APPLICATION

This application claims the benefit of Provisional Patent Application No. 202141024797, filed Jun. 3, 2021 with the Office of the Controller General of Patents, Designs and Trade Marks of India, which is incorporated by reference herein in its entirety.

### BACKGROUND OF THE INVENTION

With the increased availability of residential broadband delivery of digital video content and the ever-growing number and variety of digital video content sources, including live content, consumers are storing more content than ever on digital video recorders (“DVRs”). Many residences may even have multiple DVRs to meet the demands for content storage within a given household. These devices, often integrated into set-top boxes, offer consumers a convenient means of capturing one or more live streams of digital content for later and/or repeated viewing.

It has also become increasingly popular for residential broadband networks to deliver content employing Adaptive Bit-Rate (“ABR”) encoding such as Dynamic Adaptive Streaming over Hypertext Transfer Protocol (“DASH”) and Hypertext Transfer Protocol Live Streaming (“HLS”). ABR encoding packetizes the digital content so that it can be streamed in accordance with Internet Protocol (“IP”) standards promulgated by the Internet Engineering Task Force (“IETF”). ABR encoded contents consists a number ‘profiles’ or content in different bitrates and resolution and the clients can choose the best resolution and bit rate profile as supported by the client capability and possible due to the bandwidth available.

ABR is an emerging technology replacing more traditional, constant bit-rate streaming transmission technologies, such as those utilizing Quadrature Amplitude Modulation (“QAM”) in accordance with International Telecommunication Union (“ITU”) Recommendation J.83. It is notable that these two technologies exhibit strikingly different responses to errors encountered during both live stream transmissions and the playback of recorded content.

Streaming digital content as a series of individual data packets gives rise to the possibility of one or more packets being dropped either as a consequence of headend, transmission or reception errors or difficulties. During live playback, a brief interruption in a traditional, non-packetized video stream, such as one utilizing QAM, would typically result in the video content freezing or going blank for a short interval. Contrastingly, the dropping of a minimal number of packets within an ABR content stream can result in far more drastic content interruptions. This severity is a consequence of the system attempting to reload the dropped content. This reloading is resource intensive and delays the processing of a significant amount of ABR content (which is highly compressed). The result is a very noticeable, and likely unpleasant interruption in the viewing experience. can be worse in case of ABR content. Such interruptions can even result in the termination of content viewing.

As a consequence of the increasing availability of ABR video content, DVRs capable of recording ABR content are now available for residential use. For reasons similar to those discussed above with respect to live content, errors in the playback of recorded ABR content are likely to have a greater impact upon the viewing experience than errors encountered during the playback of recorded QAM encoded content. An error in a recorded QAM content would likely result in the missing or corrupted content simply being skipped over. The viewer might notice only a momentary discontinuity in the content. Unfortunately, recorded ABR content would likely exhibit the aforementioned unacceptably long delays and/or content termination due to one or more packets having been dropped when the ABR content was recorded.

Consequently, there exists a need for a system and method to provide fault-tolerant playback of stored ABR content, so as to minimize or avoid unacceptably long interruptions to the viewing experience, and/or the termination of content viewing.

### BRIEF SUMMARY OF THE INVENTION

A system and method enabling the storage and retrieval of packetized digital content data in a manner which minimizes the detrimental effects of dropped data packets. The dropped packets, encoded in accordance with a first profile, are detected and corresponding data packets obtained from an alternate profile of the digital content are substituted for the missing packets when the data is retrieved. Upon retrieval, the stored data packets are decoded in accordance with protocols associated with the particular profile from which each stored packet was obtained.

### BRIEF DESCRIPTION OF THE DRAWINGS

The aspects, and advantages of the present invention will become better understood with regard to the following description, appended claims, and accompanying drawings in which:

FIG. 1 is a functional block diagram of system 100 which supports the fault-tolerant playback of stored ABR content.

FIG. 2 is a flow diagram of a packetized content storage process supported by the system of FIG. 1.

FIG. 3 is a flow diagram of a packetized content retrieval process supported by the system of FIG. 1.

### DETAILED DESCRIPTION

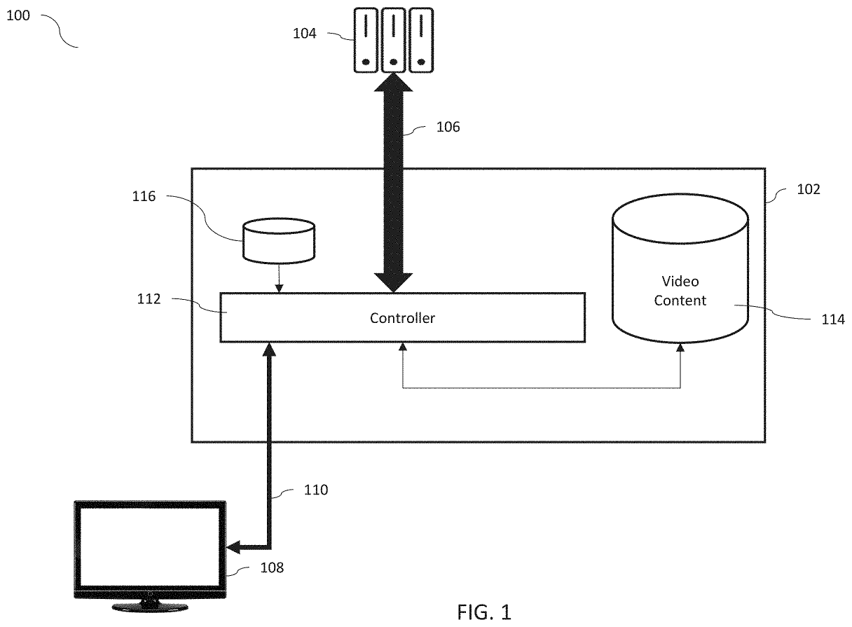

FIG. 1 provides a functional block diagram of system 100 which supports the fault-tolerant playback of stored ABR content. As shown, the system includes media gateway appliance (“MGA”) 102 which is linked to content provider headend 104 via broadband network 106. Headend 104 could be any remote source of ABR video content such as an Internet streaming service or a multi-service operator (“MSO”) headend. Broadband network 106 can be a wired or wireless network capable of supporting broadband, bidirectional communications between MGA 102 and headend 104. MGA 102 is also shown to be linked to display 108 via interface 110. Interface 110 can be a wired connection such as a coaxial cable, high-definition media interface (“HDMI”) link, or a wireless connection. MGA 102 includes controller 112 and memory 114 which are adapted to provide DVR functionality. As is typical for a DVR, incoming streaming video received via broadband network 106 is stored within video content memory 114, enabling a user to view the recorded content upon display 108 as desired.

A typical ABR source is capable of concurrently providing a given digital video content at multiple-resolutions and bitrates. Each such version of the content is referred to as a profile. For example, a particular video content could be available from an ABR source under a Standard-Definition (“SD”) profile, a High-Definition (“HD”) profile and a 4K also referred to as Ultra HD, profile. Information delineating each of these available profiles is typically provided to client MGAs as a content manifest. The client MGA can simultaneously access each of these profiles and create a series of concurrent recordings of the various content resolutions. It will be understood that the client MGA may also be programmed to record a subset of the available profiles, based upon the particular types of devices that the recorded content will be consumed upon. System 100 is adapted to record the SD, HD and 4K profiles, which will be leveraged to provide an improved, fault-tolerant DVR playback of ABR content.

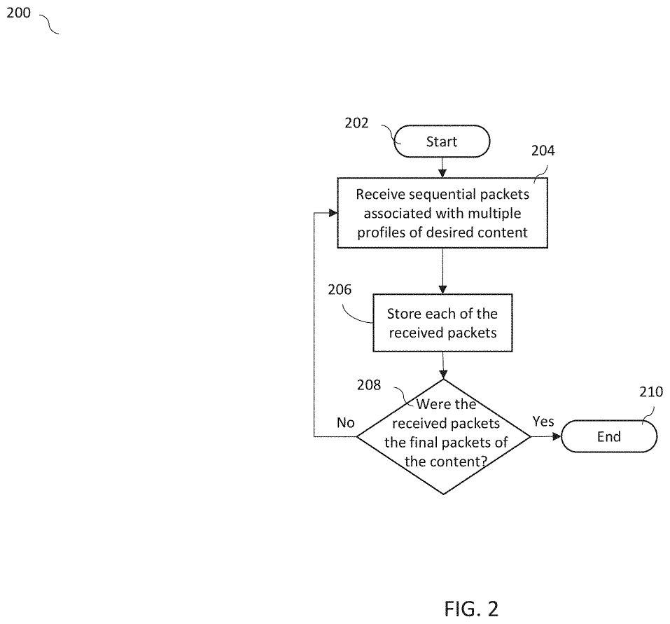

In a particular embodiment of the invention, controller 112, in accordance with instructions stored in memory 116, receives the first of the sequential ABR packets that comprise the SD, HD and 4K profiles of desired digital content from provider headend 104 (see steps 202 and 204 of FIG. 2). In step 206, controller 112 stores each of the received packets upon memory 114, so as to initiate the compilation of three stored profiles (SD, HD and 4K). Controller 112 then determines if the most recently stored packets were the final packets of the desired content profiles (step 208). If so, the process terminates (step 210). If not, the next sequential set of packets is received (step 204) and the process reverts back to step 204.

The stored corresponding packet from an alternate profile would obviously be of a different format than the other stored packets obtained from the initial profile of the desired content. Consequently, provision must be made for the proper decoding and display of the alternate profile packet. This is provided for by instructing controller 112 to generate an appropriate instruction to enable the proper decoding and display by MGA 102 upon playback, or by instructing controller 112 to store profile information obtained from the provider of the alternate profile along with the corresponding segment. MGA 102 would then decode the corresponding segment in accordance with the stored profile information.

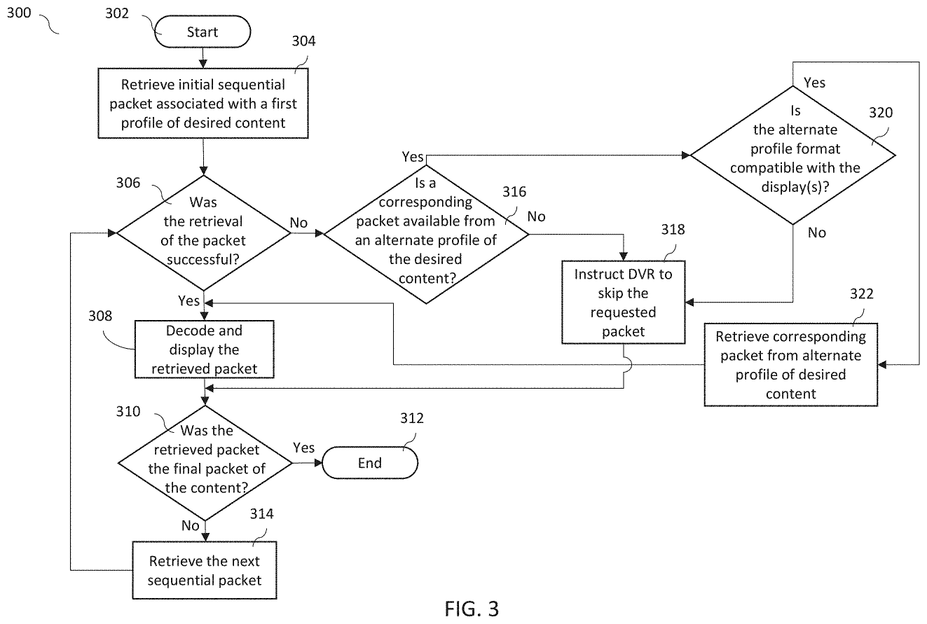

FIG. 3 provides a flow diagram of a particular process supported by the system of FIG. 1 for the retrieval of previously stored ABR content. The process initiates with the retrieval from video content memory 114 by controller 112 of the initial packet associated with a first profile of desired content (steps 302 and 304). Controller 112 then makes a determination if the retrieval was successful (step 306). If retrieval was accomplished, the process continues with step 308 and the retrieved packet is decoded in accordance with a first profile and displayed upon monitor 108 (step 308). In step 310, controller 112 makes a determination as to whether the most recently displayed packet was the final packet associated with the desired content (step 310). If so, the process terminates with step 312. If not, the process continues with step 314 and the next sequential packet in the profile is requested.

If at step 306 it was determined that the retrieval of the packet was not successful, the process would continue with step 316. In step 316, controller 112 determines if there is a corresponding packet available within an alternate profile of the desired content stored within video content memory 114. If not, controller instructs the DVR to skip the requested packet (step 318 and the process continues with step 310. This segment skipping may cause a transient freezing or discontinuity in the playback, but a single packet typically represents about four seconds of content and such a brief aberration is far preferable to the playback freezing for a much longer period, a blank screen, or the termination of the playback.

However, if step 316 resulted in an affirmative outcome, controller 112 would make a determination (step 320) as to whether the alternate profile format was compatible with the display (108) or displays associated with MGA 102. If so, the alternate profile packet would be retrieved (step 322), and the process would continue with step 308.

Although the invention herein has been described with reference to particular embodiments, it is to be understood that these embodiments are merely illustrative of the principles and applications of the present invention. Other embodiments and variations could be implemented without departing from the spirit and scope of the present invention as defined by the appended claims. For example, the types of ABR content are not limited to DASH and HLS; the invention could be applied to any ABR encoding format. The invention is also not limited to ABR data; it could be utilized with any type of packetized data, provided that multiple profiles of the data were available. In addition, it will be understood that the various connections depicted as wired in the above embodiments could also be supported by wireless connections without departing from the scope of the invention. The MGA can be a set-top box located within a consumer residence. MGA functionality can also be provided by remote systems linked to a residence via a network; this would include cloud-based implementations The controller can be a single or multi-processor system, co-located with the video content memory or remotely based in whole or in part. The memory supporting the storage of the video content can be a disk, a solid-state drive, cloud-based storage (in whole or in part), or any other means with sufficient capacity and speed to facilitate video storage and playback. Similarly, any number of various video-capable devices could serve as the display. These include digital televisions, tablets, smart phones, computer monitors, etc.

1. A system for the retrieval of packetized digital content data, comprising:
a memory device adapted to support the storage and retrieval of packetized data; and
a controller adapted to:
execute a first process requesting that a first data packet associated with a first profile be retrieved from the memory device, wherein the first data packet represents a specific portion of a particular digital content;
determine that the requested first data packet has not been successfully retrieved from the memory device as a consequence of the first request;
execute a second process, based at least in part upon the determination that the requested first data packet was not successfully retrieved, requesting that a second data packet associated with a second profile be retrieved from the memory device, wherein the second data packet represents the specific portion of the particular digital content.

2. The system of claim 1 wherein the controller is further adapted to:
determine that the requested second data packet has not been successfully retrieved from the memory device as a consequence of the execution of the second process; and
execute a third process, based at least in part upon the determination that the requested second data packet was not successfully retrieved, requesting that a third data packet associated with the first profile be retrieved from the memory device, wherein the third data packet represents a specific portion of the particular digital content that is adjacent in time to the particular digital content represented by the second data packet.

3. The system of claim 1 wherein at least one of the data packets comprises at least one of the following:
adaptive bit-rate data;
dynamic adaptive streaming over hypertext transfer protocol data;
hypertext transfer protocol live streaming data; and
data conforming to internet protocol format.

4. The system of claim 1 wherein the memory device and the controller comprise a digital video recording device.

5. The system of claim 1 wherein:
the first data packet comprises data indictive of the first profile; and
the second data packet comprises data indictive of the second profile.

6. The system of claim 1 wherein the memory device is adapted to store data packets sourced from at least one of the following:
a content delivery network;
a streaming service; and
a multi-service provider.

7. The system of claim 1 wherein the memory device comprises at least one of the following:
a disc drive;
a solid-state drive; and
a cloud-based storage system.

8. The system of claim 1 wherein the controller is further adapted to:
decode the first data packet based, at least in part, upon the first profile; and
decode the second data packets based, at least in part, upon the second profile.

9. The system of claim 8 further comprising a display adapted to receive and display the decoded data packets.

10. The system of claim 9 wherein the display comprises at least one of the following:
a digital television;
a tablet;
a computer monitor; and
a smart phone.

11. A method for the retrieval of packetized digital content data, in a system comprising a memory device adapted to support the storage and retrieval of packetized data;
the method comprising the steps of:
executing a first process requesting that a first data packet associated with a first profile be retrieved from the memory device, wherein the first data packet represents a specific portion of a particular digital content;
determining that the requested first data packet has not been successfully retrieved from the memory device as a consequence of the first request;
executing a second process, based at least in part upon the determination that the requested first data packet was not successfully retrieved, requesting that a second data packet associated with a second profile be retrieved from the memory device, wherein the second data packet represents the specific portion of the particular digital content.

12. The method of claim 11 further comprising the steps of:
determining that the requested second data packet has not been successfully retrieved from the memory device as a consequence of the execution of the second process; and
executing a third process, based at least in part upon the determination that the requested second data packet was not successfully retrieved, requesting that a third data packet associated with the first profile be retrieved from the memory device, wherein the third data packet represents a specific portion of the particular digital content that is adjacent in time to the particular digital content represented by the second data packet.

13. The method of claim 11 wherein at least one of the data packets comprises at least one of the following:
adaptive bit-rate data;
dynamic adaptive streaming over hypertext transfer protocol data;
hypertext transfer protocol live streaming data; and
data conforming to internet protocol format.

14. The method of claim 11 wherein the memory device comprises a digital video recording device.

15. The method of claim 11 wherein:
the first data packet comprises data indictive of the first profile; and
the second data packet comprises data indictive of the second profile.

16. The method of claim 11 wherein the memory device is adapted to store data packets sourced from at least one of the following:
a content delivery network;
a streaming service; and
a multi-service provider.

17. The method of claim 11 wherein the memory device comprises at least one of the following:
a disc drive;
a solid-state drive; and
a cloud-based storage system.

18. The method of claim 11 further comprising the steps of:
decoding the first data packet based, at least in part, upon the first profile; and
decoding the second data packets based, at least in part, upon the second profile.

19. The method of claim 18 wherein the system further comprises a display adapted to receive and display the decoded data packets.

20. The method of claim 19 wherein the display comprises at least one of the following:
a digital television;
a tablet;
a computer monitor; and
a smart phone.
